(19) United States
(12) Patent Application Publication
(10) Pub. No.: US 2022/0374994 A1
(43) Pub. Date: Nov. 24, 2022

(54) RISK SELECTION, RATING, DISAGGREGATION, AND ASSIGNMENT

(71) Applicant: Neptune Flood Incorporated, St. Petersburg, FL (US)

(72) Inventors: Trevor Ryan Burgess, St. Petersburg, FL (US); James Dennis Albert, St. Petersburg, FL (US); Brad Henry Schulz, Odessa, FL (US); James Edward Steiner, St. Petersburg, FL (US)

(21) Appl. No.: 17/773,996

(22) PCT Filed: Nov. 4, 2020
(86) PCT No.: PCT/US2020/058799

§ 371 Date: May 3, 2022

Related U.S. Application Data
(60) Provisional application No. 62/930,262, filed on Nov. 4, 2019.

(51) Int. Cl. G06Q 40/08

(52) U.S. Cl. CPC G06Q 40/08

(57) ABSTRACT

A system for electronically automating risk selection, rating, disaggregation, and assignment is provided. The system includes Quoting System interface software that generates graphical user interfaces that are output to a display screen of an end user computing device and that accept data relating to a risk subject to be analyzed and assigned. The risk subject data is used by a Triton software engine that interfaces with supplemental risk subject data application programming interfaces (API) to secure supplemental risk subject data relevant to analyzing and assigning the risk subject. The Triton software engine performs a risk selection analysis, a risk rating analysis, a disaggregation analysis, and a capacity analysis to quantify the risk presented by the risk subject and to determine a set of qualified facilities capable of accepting assignment of the risk subject. The Triton software engine evenly assigns the risk subjects to facilities using a market assignment process.

### TECHNICAL FIELD AND BACKGROUND

The present invention relates generally to systems and methods for evaluating and assigning risk, and more particularly, to systems and methods that enable the real-time, automated processing of risk selection, rating, disaggregation, and assignment to appropriate facilities.

Traditional systems and methods for evaluating risk rely primarily on manual user inputs, oral interviews, in-person inspections, or at best a limited number publicly accessible, outdated databases to select and rate the risk of loss associated with a risk subject. As a result, traditional methods for evaluating risk are time-consuming, labor-intensive, and inefficient. These inefficiencies coupled with limitations on the accuracy of the input data in turn limit the complexity, accuracy, and comprehensiveness of the risk evaluation.

After a risk is evaluated, the risk must be assigned to an appropriate facility based in part on the facility's concentration of existing risks with similar characteristics and the facility's capacity to compensate for losses resulting from a realized risk. By way of example, a facility offering flood insurance may be required to limit the total value of policies written in a coastal geographic area to protect against a catastrophic loss event in the area (e.g., a hurricane) and to comply with regulatory requirements. Managing the concentration of risk, a process referred to as “disaggregation,” is itself a challenging and time-consuming task that must be performed on a regular basis to ensure that risks are not assigned to a facility that has exceeded limitations on risk concentration.

As a consequence of the inefficiencies in the risk evaluation and disaggregation processes, by the time a risk evaluation is complete and approval for assignment is received, it is not uncommon for a facility's risk profile to change such that the facility can no longer accept the risk. It would, therefore, be advantageous to provide systems and methods that enable the real time evaluation of risk, disaggregation, and risk assignment.

The present invention fulfills the foregoing need by providing systems and methods, powered by a Triton automated evaluator software engine, that enable the real-time evaluation and assignment risk through Risk Selection, Risk Rating Disaggregation, and Market Assignment Processes. The system relies on a streamlined amount of initial data input concerning a risk subject to perform a seamless, real-time, automated gathering of additional risk subject data that is in turn used to generated targeted inquires to a user and to evaluate the relative probability a risk will be realized and the potential degree of loss as well as other characteristics concerning the risk. The Triton software engine evaluates risk according to customizable categories, such as geographic regions or market segment so that risk concentration and capacity can be managed effectively, efficiently, and in real time.

### SUMMARY

In one embodiment of the invention, a system for electronically automating risk selection, rating, disaggregation, and assignment includes at least one provider server processor that is coupled to at least one data storage device. The data storage device is a non-transitory computer-readable medium having integrated computer-readable code for instructing the at least one provider server processor. The data storage device also includes at least one relational database for storing one or more facility identifiers. The facilities can be enterprises configured to accept risk, such as insurers, and the facility identifiers provide a mechanism for the systems and software described herein to identify and track the facilities.

Within the relational database, the facility identifiers are each associated with one or more assigned risks, which can be insurance policies covering risk subjects such as properties or casualties presenting a potential liability or risk of loss. The assigned risks are each in turn associated within the relational database with an assigned risk value (e.g., the amount a facility will be liable for if a loss is realized), an assigned risk location data (e.g., address of an insured property) as well as facility risk selection rules that can determine the conditions pursuant to which a facility will accept a risk presented by a risk subject. Facility selection rules can include, for instance, rules declining to accept a risk subject within a particular geographic area, or in the context of flood insurance, rules declining to accept a risk presented by a property below a given elevation. The relational database also associates the facility identifiers with data and information such as an available risk threshold and an available capacity threshold.

The computer-readable code implements Quoting System interface software that is configured to generating one or more graphical user interfaces that are output to a display screen of an end user computing device, such as a laptop or smartphone. Each graphical user interface includes one or more risk subject data input elements. The risk subject data input elements can be, for instance, a text box or pull down menu associated with a narrative or image inviting the end user to input certain information to the graphical user interface. The entered information can be risk subject data relating to a potential risk subject to be assigned to a facility. The Quoting System interface software receives initial risk subject data that is input to the risk subject data input element and passes it to a Triton software engine.

The computer-readable code implements the Triton software engine, which is configured to perform operations that include passing risk subject data to a supplemental risk subject data application programming interface (“API”) that accesses a supplemental risk subject database to retrieve supplemental risk subject data. The system can utilize a wide variety of supplemental risk subject data APIs to interface with various databases, software systems, or platforms to retrieve and access data and information relevant to analyzing a risk subject. Typically, the Triton software engine passes risk subject data to the supplemental risk subject data API and in turn receives the supplemental risk subject data. To illustrate, the Triton software engine can interface with a Mapping API by passing risk subject location data, such as a mailing address, to the Mapping API and in return receiving one or more sets of geographic coordinates (e.g., Global Positioning System (“GPS”) coordinates) that correspond to the risk subject location. In another example, the Triton software engine can pass either the risk subject location data in the form of a mailing address or the supplemental risk subject data in the form of GPS coordinates to an Elevation API and in return receive elevation data that describes the elevation above sea level of real property that defines the risk subject.

The Triton software engine stores the initial risk subject data received through the graphical user interface and the supplemental risk subject data to the data storage device as Risk Subject Data that makes up part of a database record representing a risk subject. In other words, a database entry that includes a variety of information concerning the risk subject like a real property to be insured.

As part of analyzing the risk subject, the Triton software engine performs a Risk Selection Analysis to determine whether one or more of a given set of facilities can accept assignment of the risk presented by the risk subject by, for instance, issuing an insurance policy covering the risk subject. When it is a determined that a facility can accept assignment of a risk subject, the facility identifier is added to a list of Qualified Facilities that can be stored to a database. The Risk Selection Analysis includes the operations of retrieving the facility identifiers and facility risk selection rules from the data storage device. Then, for the facility identifiers, the Triton software engine applies the associated facility risk selection rules to the risk subject data to determine a list of Qualified Facility Identifiers.

The Triton software engine also performs a Rating Analysis utilizing the risk subject data to generate a risk subject rating (e.g., an acceptable premium amount to write a policy) and a risk subject value (e.g., the potential liability presented if a loss is realized). The Risk Rating Analysis can rely on statistical and other modeling techniques that characterize the probability and amount of a potential loss. The Risk Rating Analysis can vary according to the type of risk being analyzed (e.g., casualty loss, automobile insurance, health insurance, etc.) and the characteristics of the risk subject. In the case of flood insurance, the Risk Rating Analysis can consider data relating to the risk subject such as the elevation of the risk subject property, the value of any structures on the property, a base flood plain, the cost of living in the geographic area, nearby hazards, expected environmental conditions (e.g., frequency of hurricanes or precipitation), among many other relevant factors. The Risk Rating Analysis can also consider attributes and data relating to the facility to which a risk subject is assigned or market conditions, such as the capacity of a facility to satisfy liabilities from a loss (e.g., the equity or capital held by the facility), the expected incoming premiums to a facility, or current interest rates, among many other factors. Those of skill in the art will appreciate that multiple techniques and factors can be utilized in the Risk Rating Analysis determination.

The Triton software engine also performs a Disaggregation Analysis to determine whether a facility can accept a particular risk subject within a given geographic area, industry, market, or other category, as explained more fully below. The Disaggregation Analysis includes the operation of defining a disaggregation segment (e.g., a geographic area) comprising a plurality of assigned risks, and the operation of retrieving from the data storage device, for each Qualified Facility Identifier, the assigned risk value for each assigned risk within the disaggregation segment. Next, for each Qualified Facility Identifier, the Triton software engine determines a risk disaggregation concentration based on a combination of the risk subject value and the assigned risk value for each assigned risk within the disaggregation segment. And for each Qualified Facility Identifier, the Triton software engine compares the risk disaggregation concentration against the available risk threshold for the facility and removes the Qualified Facility Identifier from the list of Qualified Facility Identifiers when the risk disaggregation concentration exceeds the available risk threshold.

The Triton software engine is also configured to perform a Capacity Analysis to determine whether a facility has the resources to cover potential liabilities if the facility accepts assignment of the particular risk subject. The Capacity Analysis considers the risk values for the risks already assigned to a facility as well as the risk value for the risk subject being evaluated for possible assignment. The Capacity Analysis includes the operations of, for each Qualified Facility Identifier, determining a total risk value based on a combination of the risk subject value and the assigned risk value for each assigned risk associated with the Qualified Facility Identifier. The Triton software engine also compares the total risk value against the available capacity threshold for each Qualified Facility Identifier and removes the Qualified Facility Identifier from the list of Qualified Facility Identifiers when the total risk value exceeds the available capacity threshold.

Finally, to assign a risk subject to a particular facility, the Triton software engine uses a Market Assignment Process to balance the risk assignments and assure that no single facility is assigned too many risk subjects. The Market Assignment Process utilizes liner weight calculation techniques to determine a target number of risk subjects that each facility should be assigned, which is compared to the number of risk subjects actually assigned. The Triton software engine ascertains the difference between the target number of risk subject assignments for a facility identifier and the actual number of risk assignments received for a facility identifier. The difference is the assigned risk distance value, and the Triton software engine can be configured to assign risk subjects to the facility with the lowest assigned risk distance value to ensure the assignments remain balanced. As risk subjects are assigned, weights assigned to each facility can be recalculated to continuously ensure balanced assignment.

As discussed above, the Quoting System software interface generates graphical user interfaces that solicit and accept input concerning the risk subjects in the form of risk subject data that is used to analyze risk subjects. The Quoting System software interface can be configured to seek input in a sequential fashion that tailors the input solicited based on prior answers so that appropriate follow up information is received. This feature is implemented such that after receiving the initial risk subject data that is input to the first risk subject data input element of the first graphical user interface, the Quoting System interface software generates a second graphical user interface that is output to the display screen of the end user computing device. The second graphical user interface includes a second risk subject data input element as an integrated part of the second graphical user interface. The Quoting System interface software includes logic that selects the content of the second risk subject data input element based on the initial risk subject data that is input into the first risk subject data input element.

The Quoting System interface software logic can be illustrated by a simplified example where real property is evaluated as the risk subject. The first risk subject data input element prompts an end user to enter risk subject data by selecting a type of home represented by the risk subject. The options for the type of home can include a single-family house, a multi-story complex, and a manufactured home. If the option for a single-family house is selected, the Quoting System interface software logic generates a second graphical user interface with a second risk subject data input element that solicits relevant follow up risk subject data, such as asking the user to further specify the type of structure for the single-family house. In that case, the second risk subject data input element can prompt the entry of risk subject data selected from options that include a home on a slab, a home on a crawl space, a home with a basement, and a home on stilts or pilings. Had the type of home been specified as a multi-story complex or a manufactured home, then the Quoting System interface software logic would have presented different options for the second risk subject data input element.

In another aspect of the system, the second risk subject data input element can be implemented as an interactive map, and the risk subject data is input by graphically selecting a geographic location on the interactive map using the end user computing device.

With regard to the Market Assignment Process, the even assignment of risk subjects is ensured by tracking the number of risk subjects assigned by the system overall and the number assigned to particular facilities. Linear weighting techniques are used to balance the risk assignments by adjusting the statistical likelihood of a facility receiving an assignment as the facility reaches a risk capacity threshold.

More specifically, the system implements counters, and the Market Assignment Process includes the operation of incrementing a facility counter value each time a new risk subject is assigned to a Qualified Facility Identifier such that the facility counter value represents the number of risk subjects assigned to the Qualified Facility Identifier over a given time period. The Market Assignment Process also includes the operation of incrementing a master counter value each time any risk subject is assigned to any Qualified Facility Identifier such that the master counter value represents a total number of risk subjects assigned by the system over the given time period.

To properly apportion the risk subject assignments as the facilities reach a capacity threshold, the Triton software engine determines a capacity threshold proportion for each Qualified Facility Identifier by comparing the available capacity threshold to the total assigned risk value. The total assigned risk value is determined by the combination of all assigned risk values for each assigned risk associated with the Qualified Facility Identifier. Then the Triton software engine compares the capacity threshold proportion against a weight adjustment threshold for each Qualified Facility Identifier and performs a linear weight adjustment to a Facility Weight when the capacity threshold proportion exceeds the weight adjustment threshold. The Triton software engine determines a target distance value by utilizing the master counter value and the Facility Weight and determines the assigned risk distance value utilizing the target distance value and the facility counter value. In other words, the Triton software engine ascertains how many risk assignments the facility should have received and compares it to the actual number of risks assigned to the facility. The risk subjects are then assigned to the facility having the lowest assigned risk distance value.

In another embodiment, the system for electronically automating risk selection, rating, disaggregation, and assignment includes at least one provider server processor coupled to at least one data storage device. The data storage device comprises a non-transitory computer-readable medium with computer-readable code for instructing the provider server processors. The data storage device also includes at least one relational database that stores one or more facility identifiers. The facility identifiers stored to the relational database can each be associated with: (i) one or more assigned risks that are each in turn associated with an assigned risk value and assigned risk location data; (ii) facility risk selection rules; (iii) an available risk threshold; and (iv) an available capacity threshold.

The computer-readable code implements Quoting System interface software that is configured to perform operations such as generating one or more graphical user interfaces that are output to a display screen of an end user computing device. Each graphical user interface has one or more risk subject data input elements that receive risk subject data input by the end user computing device. The risks subject data includes risk subject location data.

The Quoting System interface software passes the risk subject data to a Triton software engine implemented by the computer-readable code. The Triton software engine is configured to perform operations such as storing the risk subject data to the data storage device as part of a risk subject database record representing the risk subject to be analyzed and assigned.

The Triton software engine passes the risk subject location data to a Mapping API. The Mapping API interfaces with a map database by utilizing the risk subject location data to obtain risk subject geolocation coordinate data corresponding to the risk subject location data. The Mapping API returns the risk subject geolocation coordinate data to the Triton software engine.

The Triton software engine also passes the risk subject geolocation data to an Elevation API. The Elevation API interfaces with an elevation database by utilizing the risk subject geolocation coordinate data to obtain risk subject elevation data corresponding to the risk subject geolocation coordinate data. The Elevation API returns the risk subject elevation data to the Triton software engine.

The Triton software engine performs a Risk Selection Analysis by first retrieving the facility identifiers and the facility risk selection rules from the data storage device. In this embodiment, the facility risk selection rules are implemented as facility risk geolocation rules that set parameters surrounding the geographic locations where a facility can accept assignment of a risk subject. That is, if the risk subject location is within certain geographic locations, the facility does not accept the risk assignment. Otherwise, the facility identifier is added to a list of Qualified Facility Identifiers. More specifically, for one or more facility identifiers, the Triton software engine applies the associated facility risk geolocation rules to the risk subject geolocation coordinate data to determine one or more Qualified Facility Identifiers, and the Triton software engine stores the Qualified Facility Identifiers to the data storage device as a list of Qualified Facilities.

The Triton software engine also performs the Rating Analysis utilizing the risk subject geolocation coordinate data and risk subject elevation data to quantify the risk subject rating and the risk subject value. The Triton software engine further performs a Disaggregation Analysis that considers geographic factors where the analysis includes the step of defining a geographic disaggregation area such that the risk subject geolocation coordinate data falls within the geographic disaggregation area. For each Qualified Facility Identifier in the list of Qualified Facilities, the Triton software engine utilizes the assigned risk location data to retrieve from the data storage device the assigned risk value for each assigned risk within the geographic disaggregation area. Next, for each Qualified Facility Identifier, the Triton software engine determines a risk disaggregation concentration based on a combination of the risk subject value and the assigned risk value for each assigned risk within the geographic disaggregation area. The Triton software engine then compares the risk disaggregation concentration against the available risk threshold and removes the Qualified Facility Identifier from the list of Qualified Facilities when the risk disaggregation concentration exceeds the available risk threshold.

Prior to assigning a risk subject, the Triton software engine also analyzes the capacity of the Qualified Facilities to absorb a potential risk subject loss by performing a Capacity Analysis. The Capacity Analysis includes the operation of, for each Qualified Facility Identifier, retrieving from the data storage device, the assigned risk value for each assigned risk associated with the Qualified Facility Identifier. The Triton software engine determines a total risk value for each Qualified Facility Identifier based on a combination of the risk subject value and the assigned risk value for each assigned risk associated with the Qualified Facility Identifier. For each Qualified Facility Identifier, the total risk value is compared against the available capacity threshold, and the Qualified Facility Identifier is removed from the list of Qualified Facilities when the total risk value exceeds the available capacity threshold.

Lastly, the Triton software engine performs a Market Assignment Process by performing the operation of determining an assigned risk distance value for each Qualified Facility Identifier. The Triton software engine assigns the risk subject to the Qualified Facility Identifier associated with the lowest assigned risk distance value to ensure appropriate balance in assigning the risks.

In some cases, it is advantageous to determine the elevation at multiple points on real property that constitutes a risk subject. This provides a more accurate insight into the characteristics of the risk subject, including the elevation at a point where structures on the property might be located. In such embodiments, the risk subject geolocation coordinate data returned from the Mapping API includes a plurality of geographic coordinate pairs representing points on a map. The Triton software engine can pass either one or both of the risk subject location data or the risk subject geolocation coordinate data to a Property API.

The Property API interfaces with a property database by utilizing the risk subject location data or the risk subject geolocation coordinate data to obtain risk subject structure location data (e.g., the location of any structures on the risk subject real property). The Triton software engine then determines a risk subject structure elevation by correlating the risk subject structure location data to at least one geographic coordinate pair and the correlated elevation data value. Put another way, the elevation is determined at the point (or points) on a property where a structure is located.

In another embodiment, the location of a structure on a risk subject real property is selected by an end user computing device where the graphical user interface risk subject data input element is implemented as an interactive map. The risk subject structure location data is graphically input to the interactive map using the end user computing device. The Triton software engine then determines the risk subject structure elevation by correlating the risk subject structure location data to at least one geographic coordinate pair and the correlated elevation data value. Again, put another way, the elevation is determined at the point (or points) on a property where a structure is located, as indicated by a graphical selection on the interactive map.

The system can also utilize information concerning the construction of structures on a risk subject real property or utilize base flood elevation data as inputs to the Risk Selection and Risk Rating Analyses. As part of ascertaining this information, a user can be prompted by a graphical user interface to input risk subject data into the risk subject data input element that includes a year of structure construction and structure type information. The Triton software engine passes the year of structure construction or the structure type information to a Construction Information API. The Construction Information API interfaces with a construction information database by utilizing the year of structure construction or the structure type information to obtain a structure construction height. The Construction Information API returns a structure construction height to the Triton software engine. The Triton software engine then determines a front door elevation value utilizing the risk subject elevation data and the structure construction height.

To capture base flood elevation, the Triton software engine passes at least one of the risk subject location data or the risk subject geolocation coordinate data to a Base Flood Elevation API. The Base Flood Elevation API interfaces with a base flood elevation database by utilizing the risk subject location data or the risk subject geolocation coordinate data to obtain base flood elevation data. The Base Flood Elevation API returns the base flood elevation data to the Triton software engine. The Triton software engine determines an elevation difference value utilizing the base flood elevation data and the front door elevation value.

In yet another embodiment, the rules for determining whether a facility will accept a risk include considering whether the risk subject elevation data meets a predetermined threshold. In that case, the facility risk selection rules are implemented as facility risk elevation rules. The Risk Selection Analysis includes the step of, for one or more facility identifiers, applying the associated facility risk elevation rules to the risk subject elevation data to determine one or more Qualified Facility Identifiers.

Turning to the disaggregation analysis, in some instances, the geographic disaggregation area is defined as being coextensive with a zip code. The geographic disaggregation area can also be defined by a radial center point and a radial set point that extends a distance from the radial center point. The Disaggregation Analysis considers only those assigned risk subjects within the radial by determining for each Qualified Facility Identifier, whether the distance between the assigned risk location data and the radial center point is less than the radial set point. In determining the risk subject value and the assigned risk value for each assigned risk, the system can use multiple methods, including a total insured value calculation or an annual average loss calculation.

Also disclosed herein is a method for electronically automating risk selection, rating, disaggregation, and assignment. The method includes the step of creating at least one relational database on a data storage device where the relational database stores one or more facility identifiers each associated within the relational database with (i) one or more assigned risks, wherein the one or more assigned risks are each associated with an assigned risk value and assigned risk location data, (ii) facility risk selection rules, (iii) an available risk threshold, and (iv) an available capacity threshold.

The method also includes the step of generating by the Quoting System interface, a graphical user interface that is output to a display screen of an end user computing device. The graphical user interface includes an integrated risk subject data input element that accepts risk subject data relating to a risk subject to be analyzed and assigned. The Triton software engine receives the risk subject data and passes the risk subject data to a supplemental risk subject data application programming interface (API) that accesses a supplemental risk subject database to retrieve supplemental risk subject data. The method can include utilizing a variety of types of supplemental risk subject data APIs to data and information relevant to analyzing and assigning the risk subject. For instance, the supplemental risk subject API can be implemented as one or more of a Mapping API, Elevation API, Base Flood Elevation API, Property API, or Construction Information API. The APIs can capture and determine supplemental risk subject data such as risk subject geolocation coordinates, elevation data or base flood elevation data for real property risk subjects, or information relating to the location, height, or type of construction for any structures on real property risk subjects.

The method utilizes the risk subject data to perform a Risk Selection Analysis by the Triton software engine. The Risk Selection Analysis includes performing the steps of, for one or more facility identifiers, applying the associated facility risk selection rules to the risk subject data to determine a list of Qualified Facility Identifiers. The Triton software engine also performs a Rating Analysis utilizing the risk subject data to generate a risk subject rating and a risk subject value.

In another aspect of the invention, the Triton software engine performs a Disaggregation Analysis that includes the step of defining a disaggregation segment utilizing the risk subject data where the disaggregation segment comprises a plurality of assigned risks. For one or more of the Qualified Facility Identifiers, the assigned risk data is used to identify each assigned risk within the disaggregation segment and retrieving from the data storage device, the assigned risk value for each assigned risk within the disaggregation segment. To illustrate, in embodiments were the disaggregation segment is a geographic area and the risk subject data includes location data, the disaggregation segment can be defined as a geographic disaggregation area that includes the location of the risk subject. The Triton software engine also uses the assigned risk data, which can include location data for the assigned risks, to identify those assigned risks that are within the geographic area defining the disaggregation segment.

The Disaggregation Analysis also includes the step of determining a risk disaggregation concentration for one or more of the Qualified Facility Identifiers based on a combination of the risk subject value and the assigned risk value for each assigned risk within the disaggregation segment. Then, for the Qualified Facility Identifiers, the method compares the risk disaggregation concentration against the available risk threshold and removes the Qualified Facility Identifier from the list of Qualified Facility Identifiers when the risk disaggregation concentration exceeds the available risk threshold.

The method includes steps for the Triton software engine to perform a Capacity Analysis where, for each Qualified Facility Identifier, the Triton software engine determines a total risk value based on a combination of the risk subject value and the assigned risk value for each assigned risk associated with the Qualified Facility Identifiers. Then, for each Qualified Facility Identifier, the Triton software engine compares the total risk value against the available capacity threshold and removes the Qualified Facility Identifier from the list of Qualified Facility Identifiers when the total risk value exceeds the available capacity threshold.

Lastly, the method includes steps for the Triton software engine to perform a Market Assignment Process. For the Market Assignment Process, the Triton software engine determines an assigned risk distance value or the Qualified Facility Identifiers. Then the risk subjects are assigned to the Qualified Facility Identifier associated with the lowest assigned risk distance value.

### BRIEF DESCRIPTION OF THE DRAWINGS

Features, aspects, and advantages of the present invention are better understood when the following detailed description of the invention is read with reference to the accompanying figures, in which:

FIG. 1 is an exemplary system diagram according to one embodiment.

FIG. 2 is an exemplary process according to one embodiment.

FIG. 3 illustrates an exemplary graphical user interface according to one embodiment.

FIG. 4 illustrates an exemplary graphical user interface according to one embodiment.

FIG. 5 illustrates an exemplary graphical user interface according to one embodiment.

FIG. 6 illustrates an exemplary graphical user interface according to one embodiment.

FIG. 7 illustrates an exemplary process for Disaggregation according to one embodiment.

FIG. 8 illustrates an exemplary process for Market Assignment according to one embodiment.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete and will fully convey the scope of the invention and enable one of ordinary skill in the art to make, use, and practice the invention.

It will be understood that relative terms are intended to encompass different orientations or sequences in addition to the orientations and sequences depicted in the drawings and described herein. Relative terminology, such as “substantially” or “about,” describe the specified devices, materials, transmissions, steps, parameters, or ranges as well as those that do not materially affect the basic and novel characteristics of the claimed inventions as whole as would be appreciated by one of ordinary skill in the art. The nomenclature utilized to designate various devices and software applications is not intended to be limiting, and reference to a device or application with a particular commercial, proprietary, or other name can be construed to encompass other devices and applications that perform a similar function or have a similar structure.

Disclosed are systems and methods that enable the real-time, automated processing of risk selection, rating, disaggregation, and market assignment. The exemplary embodiments disclosed herein are described with reference to evaluating and processing risk associated with establishing flood insurance policies. However, those of ordinary skill in the art will appreciate that the disclosed systems and methods could be applicable to evaluating and processing other types of risks in other industries and contexts.

As used herein, the term “provider” generally describes an entity that evaluates and assigns a given risk utilizing the inventive systems and methods disclosed herein. The term “facility” is used interchangeably with the terms “capacity provider,” “binding authority,” or “insurer” and refers to an entity that undertakes to be financially responsible for a given risk of loss or casualty to a subject person or property in exchange for payment, such as an insurance premium or deductible. The term “risk subject” is used herein to denote the person or property that is to be secured against a loss through an insurance policy and can include, for example, personal property, real property (including a dwelling or structure located on such real property), or a person whose health or life is to be insured. The terms “user” or “policy holder” generally denote an individual that is associated with the risk subject and that seeks to secure the risk subject against a loss or casualty using the present systems and methods.

The systems and methods disclosed herein provide a graphical user interface that accepts streamlined initial risk subject data inputs from a user. The initial risk subject data is transmitted to a Triton software engine that utilizes the initial risk subject data to gather supplemental subject data from one or more supplemental databases. The supplemental databases can be local or remote to the Triton software engine and hosted or maintained by a third-party data provider. The initial or supplemental risk subject data can be used to generate targeted, customizable queries called risk subject data input elements that are presented to the user to seek targeted risk subject data useful for evaluating a risk subject.

The initial, supplemental, and/or targeted risk subject data are used to perform a Risk Selection Analysis and a Risk Rating Analysis. The Risk Selection Analysis evaluates whether a particular risk subject meets underlying qualifications of an insurance policy product provided by a facility. As a simplified example, if the Risk Selection Analysis shows that a particular property (i.e., a risk subject) is located five (5) feet below sea level, then the risk subject would not fit the criteria of an insurance policy product that covers only flood losses for properties above sea level. The Risk Rating Analysis evaluates the degree of a particular risk and can be translated to, for instance, an insurance premium payment amount. The Risk Selection and Risk Rating analyses rely on a combination of rule-based and quantitative modeling steps.

Following the Risk Selection and Risk Rating Analysis, the system performs a Risk Disaggregation Analysis that considers a facility's concentration of risks of a certain type or that share common characteristics, such as risks within a given geographic area or market segment. As part of the Risk Disaggregation Analysis, the system additionally conducts a Capacity Analysis that examines a facility's capacity or ability to adequately compensate for losses resulting from a covered risk. Both risk concentration management and capacity management are critical to ensuring continued successful operation of a facility and to protecting against extensive losses that would otherwise entirely consume a facility's resources and undermine the facility's ability to compensate for additional losses from realized risk.

The result of the Risk Section, Risk Rating, Disaggregation, and Capacity analyses is to identify suitable facilities for assignment of a risk. The suitable facilities are stored to a database as a list of “Qualified Facilities” that are identified with a facility identifier. Risk subjects are assigned based on a Market Assignment Process that utilizes weighted, round-robin techniques to distribute risks to suitable facilities based on available capacity or other relevant factors. Details of the inventive system and methods as well as the particular analyses are discussed in more detail below.

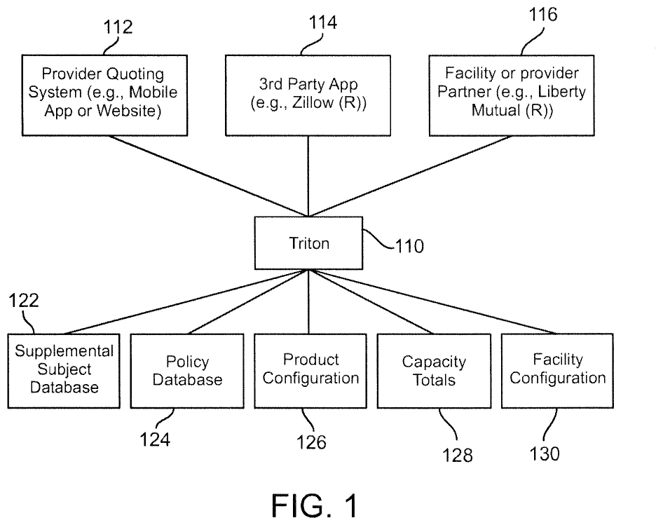

Turing to FIG. 1, an example system configuration according to one embodiment includes: (1) a Triton software engine 110; (2) one or more graphical user interfaces generated by Quoting System interface software where the graphical user interfaces are associated with, for example, a provider website or mobile software application 112, a third-party software application 114, or a facility partner 116; (3) a supplemental risk subject database 122; (4) a policy database 124; (5) a product configuration database 126; (6) a capacity database 128; and (7) a facility configuration database 130. The system embodiment shown in FIG. 1 is not intended to be limiting, and those of ordinary skill in the art will recognize that the systems and methods of the present invention may be implemented using other suitable hardware or software configurations. For example, the supplemental risk subject database 122, policy database 124, product configuration database 126, capacity database 128, and/or facility configuration database 130 can be implemented as a single relational database residing on a data storage device that includes a non-transitory computer-readable medium. Alternatively, the system may utilize multiple supplemental risk subject databases 122, only a single user interface (112, 114, or 116), or the single Triton software engine 110 shown in FIG. 1 can be implemented by two or more separate software modules running on one or more computing devices.

The various system components are generally implemented by software applications running on one or more physical or virtual computing devices. To illustrate, in one embodiment, the provider Quoting System interface software 112 is implemented as a mobile software application running on a mobile computing device that is in electronic communication with a separate provider server running the Triton software engine 110. Alternatively, the Quoting System interface software 112 can be implemented as a website hosted on a virtual web server that is in turn running on the same physical computing device as the Triton software engine 110.

The computing devices may also utilize software applications that function using resource available through a third-party provider, such as a Software as a Service (“SasS”), Platform as a Service (“PaaS”), or Infrastructure as a Service (“IaaS”) provider running on a third-party cloud service computing device. For example, a cloud computing device may function as a policy database 124 by providing remote data storage capabilities.

Users access the user interfaces (112, 114, or 116) through a personal computing device, such as a desktop computer, laptop computer, a cellular smart phone, or tablet computing device. The personal computing device that includes an integrated software application configured to operate as a user interface and to provide two-way communication with the provider's computer system running the Triton software engine 110. The integrated software application interfaces with a communication subsystem to provide for a secure connection with other electronic devices. The various computing devices and software applications communicate using a variety possible connections that can include, for example, a local area network, a wide area network, an intranet, an Internet connection, a mobile telephone network, a personal area network, or any other suitable connection.

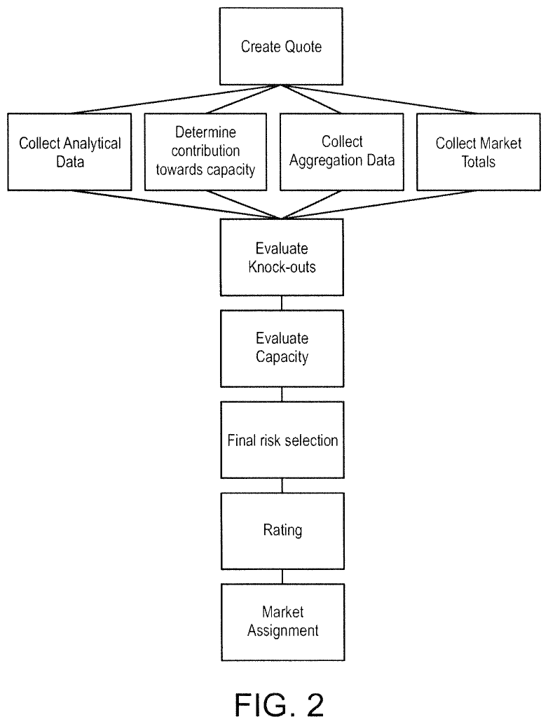

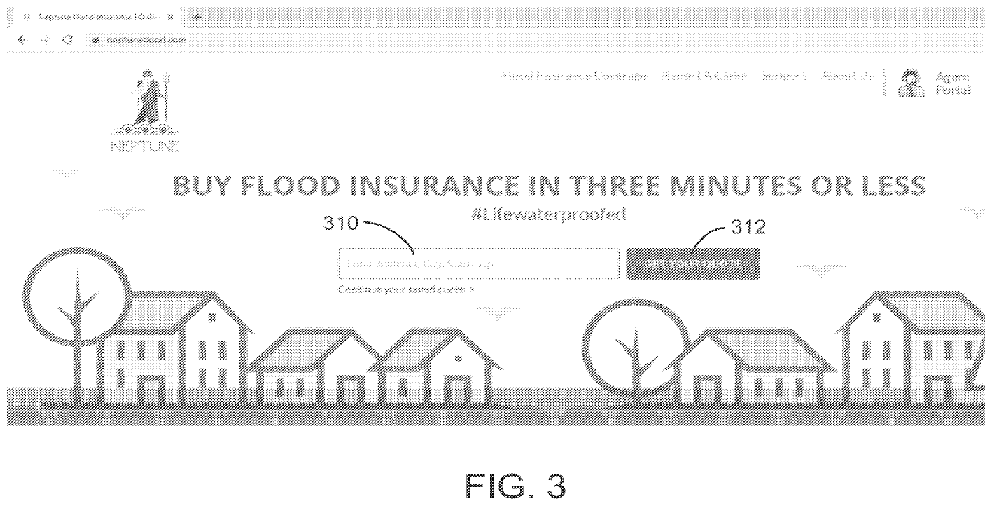

Turning to the process flow shown in FIG. 2, the Risk Selection and Rating Analyses begin when a user initiates the Create Quote step through a graphical user interface (112, 114, or 116) generated by the Quoting System interface software. An exemplary provider graphical user interface for purchasing flood insurance is shown in FIG. 3 where the risk subject is real property and the risk to be secured against is the risk of loss due to flooding. The user is prompted to enter risk subject data, such as a mailing address for the real property. The user enters the mailing address into the risk subject data input element 310, which is implemented as a text box with accompanying text. The user then selects the Get Your Quote 312 function to continue the process and transmit the risk subject data to the Triton software engine 110.

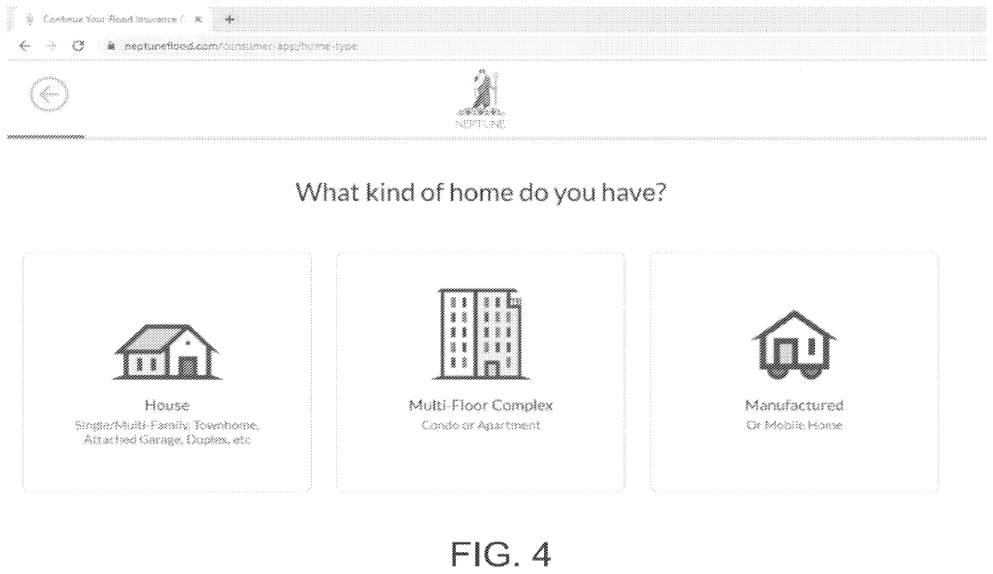

In addition to address information, the system can optionally request other types of risk subject data from the user either before or after the initial entry (i.e., the mailing address) is transmitted to the Triton software engine 110. Continuing with the example embodiment for assigning flood risk to a facility providing flood insurance, the user can be presented with a graphical user interface, such as the interface shown in FIG. 4, asking the user to specify the type of structure on the real property that is to be secured against a loss, such as whether the structure is a single family home, a multi-floor complex, or a manufactured structure.

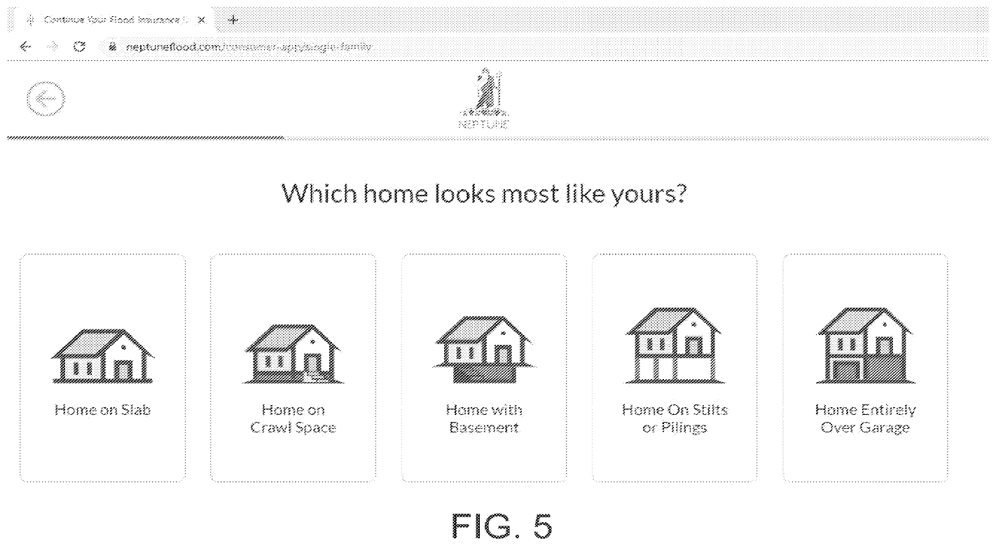

The Quoting System interface software 112 can include logic that presents users with graphical user interfaces and risk subject data input elements that are generated based on a user's prior risk subject data inputs. That is depending on the user's response to the initial queries, the user may be asked to provide more granular, second-level data and information. For instance, as depicted in FIG. 5, if the user indicates that the real property includes a single-family home, the system can present the user with an interface that further asks whether the structure: (i) is situated on a concrete slab; (ii) sits above a crawl space, basement, or garage; or (iii) is elevated on stilts or pilings. As another example, if the user indicates that the structure is a multi-floor complex, the system may present the user with an interface that inquires whether the risk subject includes a dwelling or structure that is: (i) on the ground level; (ii) located above a garage; or (iii) located on the second floor (or higher) of the multi-complex structure.

Turning again to the process flow shown in FIG. 2, after the Triton software engine 110 receives one or more categories of risk subject data, the Triton software engine 110 initiates the Collect Analytical Data step by communicating with a one or more supplemental risk subject databases 122, among other sources, to gather supplemental risk subject data. The initial risk subject data and supplemental subject data can in turn be used by the Quoting System interface software 112 logic to create targeted inquiries to the user for further relevant information and/or to begin conducting the Risk Selection, Risk Rating, and Disaggregation analyses. Once the initial risk subject data, supplemental risk subject data, and/or targeted risk subject data is gathered, the various received data can be stored to a data storage device as part of a risk subject database record representing a risk subject.

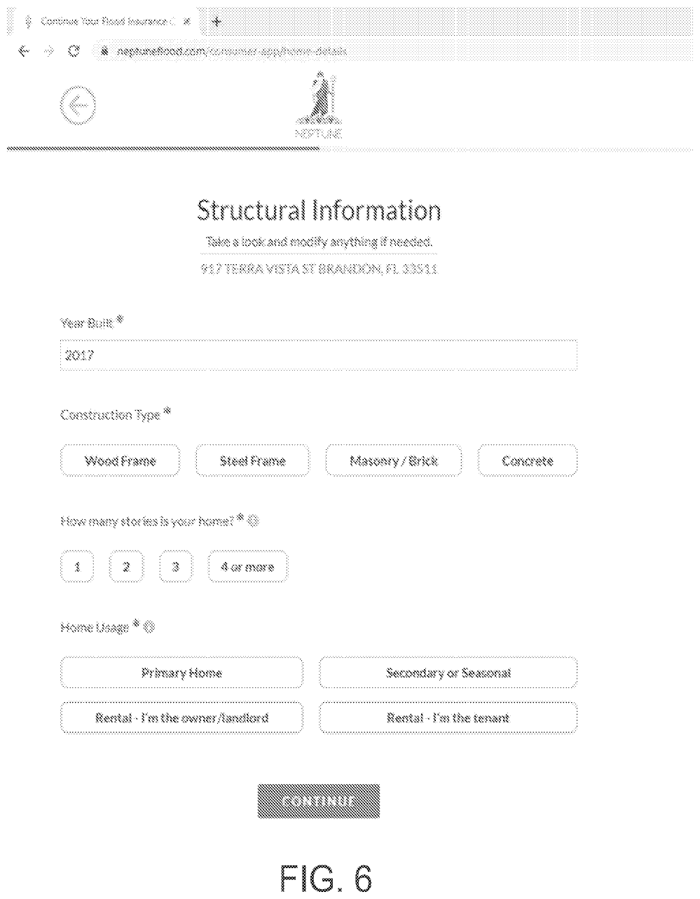

The automated gathering of supplemental risk subject data and generation of targeted inquiries has the advantage of making the risk assessment process substantially more efficient compared to conventional methods in part by allowing a user to initiate the assessment process through providing a streamlined amount of initial risk subject data. To illustrate, the embodiment depicted in FIGS. 3 through 6 permits a user to initiate the process of assessing and placing a flood risk by entering only an address and a few details about structures on the real property that are likely known or readily ascertainable by the user. The system presents the user with targeted follow up inquiries that are more likely to be directly relevant to assessing the risk in a given case so that, for instance, a user seeking to assign risk associated with a single family dwelling is not asked questions that are relevant only to a multi-floor apartment complex.

Moreover, the system also allows a provider to gather detailed risk subject data from a wide variety of databases to improve the accuracy of the risk assessment. Once a streamlined amount of risk subject data is gathered from the user, the system seamlessly gathers detailed supplemental risk subject data and performs the Risk Selection Analysis, Risk Rating Analysis, and Market Assignment Processes in real time.

In an exemplary embodiment that evaluates flood risk, gathering supplemental risk subject data can include gathering ground elevation and geolocation data from an external supplemental risk subject database 122. In that case, the Triton software engine 110 relies on various APIs, such as a Mapping API, to communicate with a risk subject database 122 that includes data correlating mailing address information to ground elevation information and to latitude and longitude geographic coordinates. The Triton software engine 110 passes the address information received from the user computing device to the Mapping API and in turn receives ground elevation and geolocation data associated with the mailing address.

The triton software engine 110 can utilize similar techniques to gather information from other supplemental risk subject databases 122 maintained by the provider or by third parties. With regard to evaluating risk associated with flooding, the Triton software engine 110 may gather supplemental risk subject data relating to the real property at issue as well as data relating to the probability that the real property will be flooded and the potential water levels experienced during a flood. Relevant real property information could include: (i) precise orientation and location information for structures located on the real property; (ii) the year structures on the real property were built; (iii) the type of construction for the structures (e.g., wood frame, concrete block, etc.); or (iv) any other data relevant to conducting a Risk Selection and Risk Rating Analysis. Relevant data relating to flooding statistics could include, but is not limited to: (i) whether the real property is located in an area designed as a 10-year, 20-year, or 100-year, etc. flood zone (i.e., 10%, 5% or 1% risk of flooding each year); and (ii) the expected water levels during a flood event (known as the “base flood elevation”).

The gathered supplemental risk subject data can be utilized to initiate the Risk Selection Analysis as well as to create additional targeted inquiries to the user to gather additional targeted risk subject data. With regard to additional targeted inquiries, supplemental risk subject data may indicate, for example, that the year of construction or the precise location of structures on the real property could not be ascertained. In that case, the system could optionally request that the user enter a year of construction or present the user with a map graphical user interface that allows the user to select a location on the property where any structures are located. The targeted risk subject data could in turn be utilized to determine whether the structures are likely to be elevated according to more recent construction standards or whether the structures are located on a portion of the real property that is located at a higher elevation, subject to higher or lower flood risks, or subject to a higher or lower base flood elevations, among other factors.

The Triton software engine 110 relies on the initial, supplemental, and targeted risk subject data to perform the Risk Selection and Risk Rating Analyses. The Risk Selection and Rating Analyses are performed in real time and are configured to utilize both rule-based qualitative and quantitative modeling analytical steps. The Risk Selection Analysis is also configurable to evaluate multiple levels of nested inquires or analytical steps that can evaluate and categorize of risks according to a wide variety of simultaneous parameters. The results of the Risk Selection Analysis are used to render a binary decision (i.e., a “yes” or “no”) as to whether a risk is suitable for particular facilities as well as to quantify the probability and possible degree of risk (i.e., how likely is the risk to occur and how severe the potential losses could be).

The features of the Risk Selection and Risk Rating Analyses of the present system and methods represent substantial improvement over traditional systems. The system enables Risk Selection and Risk Rating Analyses that are performed in real time and that can consider and correlate data from a wide variety of sources. Further, the ability to perform real-time analyses utilizing complex, multimodal analytical techniques allows for efficient and accurate risk evaluation. The feature whereby the variation in relevant risk parameters can be considered across a risk subject, such as considering variations in ground or base flood elevation across real property, further enhances the risk assessment used by the present system over traditional systems.

The Risk Selection Analysis begins with a knock-out evaluation, as depicted in FIG. 2, that renders a binary decision as to whether a risk is suitable for particular facilities. The knock-out evaluation can incorporate rules established by both the provider and the facilities to determine whether a particular risk meets the underlying qualifications for a facility or facility product. For each risk being assessed, the Triton software engine 110 retrieves applicable provider, facility, or product rules from the Policy 124, Product Configuration 126, and Facility Configuration databases 130.

The knock-out evaluation can apply rules at the provider system level or facility level. For instance, with reference to evaluating a flood risk, the knock-out analysis can include a system wide rule applicable to all providers that disqualifies assignment of risks corresponding to real property located within a particular geographic area, such as a city or zip code identified in the mailing address provided by the user. At the facility level, some facilities can implement a rule that disqualifies assignment risks associated with mobile, manufactured structures while other facilities do not include such a rule. As each risk is evaluated, the system maintains a database list of Qualified Facilities. Facilities that do not meet a given rule, such as not accepting assignment of risks for mobile manufactured structures, are removed from the list of Qualified Facility database or associated with a flag or other indicator representing the facility's ability to accept assignment of a risk (e.g., setting a flag to “1” if the facility can accept a risk and a “0” if it cannot).

The knock-out evaluation may also incorporate a quantitative component or a multi-level analysis. As an example, the knock-out evaluation may disqualify a risk assignment corresponding to real property having geolocation data falling within a customized geographic area specified by a facility. The customized geographic area can be defined by, for example, a radial that disqualifies all risks located within a set distance from established coordinates. After obtaining geographic location data for the risk subject, the Triton software engine 110 determines the distance between the risk subject geolocation and the established coordinates and rule obtained from the facility configuration database 130 to determine whether the risk subject falls within the disqualified radial. In this manner, the knock-out evaluation is implemented using both quantitative and qualitative analytical steps.

Those of ordinary skill in the art will appreciate that the above examples are not intended to be limiting, and the knock-out evaluation can rely on a wide variety of quantitative or qualitative rules and analytical steps. Other embodiments can disqualify risks based on multiple levels of parameters, such as disqualifying a risk represented by a dwelling located on the first floor of a multi-floor complex and that is also located within a given zip code. The knock-out evaluation can also incorporate rules that are not directed to evaluating risk, such as a logical check that compares a risk being evaluated against previously assigned risks stored to a Policy database 124 to ensure that a risk is not assigned twice.

In addition to a knock-out evaluation, the Risk Selection Analysis incorporates modeling techniques designed to calculate customizable quantitative parameters that correlate to the relative likelihood that a risk will result in a realized loss as well as the degree of potential loss. Continuing with the exemplary embodiment for placing a flood risk, the system may use a Base Flood Elevation API to gather base flood elevation data from multiple supplemental risk subject databases 122 that may need to be normalized so that the data is comparable. In one simplified example, a first supplemental risk subject database 122 might provide 1-year and 20-year base flood elevation data while a second source provides 10-year base flood elevation data. In that case, linear extrapolation techniques can be used to calculate a 10-year base flood elevation for the first supplemental risk subject database 122 so that it is more readily compared to data from the second supplemental risk subject database 122. The Risk Selection Analysis can use customized modeling techniques to determine an accurate base flood elevation, such as averaging all flood elevation data received from various source or relying on the one or two lowest levels.

The Risk Selection Analysis can consider additional factors specific to a given risk subject, such as the ground elevation corresponding to a known structure on the property (as opposed to an average ground elevation on the property as a whole) or a “front-door” elevation that considers the ground elevation and whether the structure is elevated on stilts or sits above a crawl space. In this manner, a more accurate estimate of the elevation for the risk subject structure can be ascertained and compared to base flood elevation data to calculate an “Elevation Difference” that more accurately quantifies the risk presented by a risk subject as compared to merely relying on base flood elevation data alone or merely relying only on whether the risk subject is located in a known flood zone or not. In other words, two properties having the same base flood elevation will not necessarily present the same probably of loss or degree of potential loss. If one property has an elevated structure and a corresponding higher Elevation Difference, then that property may present a lower probability of loss and a smaller degree of loss should a risk be realized.

The results of the Risk Selection Analysis can be again used to make a binary decision about whether a facility is a Qualified Facility, such not assigning risks having an Elevation Difference above or below a particular threshold. The results of the Risk Selection Analysis can also be utilized in the Risk Rating Analysis, which considers both the likelihood that a risk will be realized and the overall degree, or economic value, of a potential loss. The result is an assessment of required premium payments for assigning a given risk to a particular facility.

Continuing with the above example, if the Elevation Difference or other customizable parameter indicates that the risk of loss is lower, the premium payments can be adjusted downward accordingly as part of the Risk Rating Analysis. The Risk Rating Analysis may consider data relevant to ascertaining the value of the risk subject, which is relevant to evaluating the degree of the potential loss. Relevant factors can include, but are not limited to, the geolocation of the risk subject real property, the year any structure on the risk subject property was built, the type of construction, among other factors.

Risk subject assessment further considers the results of a real-time Disaggregation Analysis that evaluates facility risk concentration. Risk concentration examines the overall amount of risk of a particular type or sharing particular characteristics currently assigned to a facility. Accepting assignment of too much risk of a certain type or sharing particular characteristics can increase a facility's exposure to a catastrophic loss event. It is, therefore, advantageous for facilities to diversify risk holdings in part through reliance on the Disaggregation Analysis. When evaluating a risk, if assigning the risk to a given facility would cause the given facility's risk concentration to exceed a predetermined threshold, then the facility is removed from the database of Qualified Facilities or otherwise associated with an indicator that the facility is not available to accept assignment of the risk.

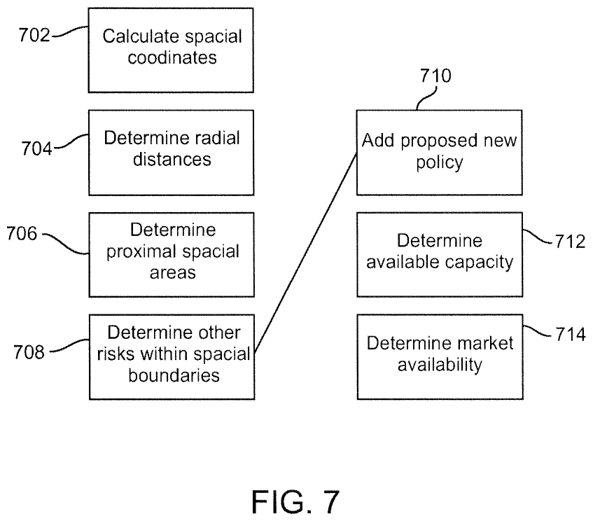

The Disaggregation Analysis can utilize a variety of metrics or characteristics to quantify and categorize the amount of risk for determining risk concentration. In the context of assigning flood risk, amount of risk can be measured using the total insured value (“TIV”) or average annual loss (“AAL”) for all risk currently assigned to a facility, and the risk can be categorized according to geographic area or market segment. Thus, the risk concentration is determined as the TIV or AAL for all risks assigned to a facility over a given geographic area. FIG. 7 illustrates exemplary steps for determining risk concentration and capacity over particular geographic areas.

The Triton software engine 110 performs the Collect Aggregation Data and Collect Market Totals steps shown in FIG. 2 to gather data concerning the TIV, AAL, and Available Risk Threshold value for each Qualified Facility. In one embodiment, the Triton software engine 110 gathers information concerning the TIV or AAL for each risk assigned to a facility as well as location data associated with each risk. The Triton software engine 110 determines the risk concentration by totaling the TIV or AAL values for each risk within a specified geographic area, such as a city, state, or zip code where the risk concentration calculation also includes the risk presently being evaluated by the system. In other words, the insured value or AAL for the risk currently being evaluated for possible assignment is added to the insured value or AAL for the risks previously assigned and currently held for a given facility. The risk concentration is then compared against the predetermined Available Risk Threshold value for each facility for a given geographic area or market segment. If the risk concentration is above the Available Risk Threshold for that area or segment, then the result of the Disaggregation analysis would be to remove the facility from the database of Qualified Facilities.

In other embodiments, the Triton software engine 110 is configured to calculate the risk concentration over a customizable geographic area, such as a specified radial or geometric polygon. The use of customizable geographic areas can provide a more accurate assessment of risk concentration in circumstances where standardized geographic regions do not correlate to actual risk. As an example, a given zip code might have only a small, low lying area surrounding a lake that is at risk for a catastrophic flood event. In that case, a risk concentration calculation might more accurately reflect a facility's exposure to a catastrophic event by defining a radial extending a pre-defined Radial Set Point distance from the geographic Center Point of the lake or the risk subject itself and totaling the TIV and AAL data within the defined radial.

Calculation of a radial is illustrated with reference to FIG. 7. For each risk subject including previously assigned risks and the risk presently under evaluation for assignment the Triton Software engine 110 obtains geolocation data 702 and calculates the radial distances 704, 708 from each risk subject to a predetermined radial Center Point. The Triton software engine 110 identifies each risk subject that has a radial distance smaller than the Radial Set Point and totals the risk concentration for each such risk subject within the radial, including the risk subject under evaluation 710. The Triton software engine 110 compares the total risk concentration to the Available Risk Threshold to determine the available capacity 712 and whether a given facility should be included within the list of Qualified Facilities 714.

In yet other embodiments, a defined polygon shape can be used to define the geometric area for calculating risk concentration, such as when a natural feature like a hill creates a natural boundary for an area that might otherwise be at risk for flooding. The system can also define different radials or polygon shapes for different geographic areas, such as defining radials and Acceptable Risk Thresholds for the northern part of a state and separate radials and Acceptable Risk Thresholds for the southern part of a state.

The Disaggregation analysis further includes a Capacity analysis that identifies the facilities that have sufficient resources, or capacity, to compensate for losses resulting from a realized risk. Similar to risk concentration, capacity can also be evaluated according to standardized or customizable geographic areas. The Triton software engine 110 gathers facility capacity information and an Available Capacity Threshold value from the Capacity Total database 128 and performs the Evaluate Capacity step shown in FIG. 2. The total capacity for a facility is calculated over a given geographic area or market segment (i.e., the amount of reserved capital) and compared against the value of potential loss over a given geographic region to determine whether the facility capacity exceeds the Available Capacity Threshold value for that area or market segment. The capacity and potential loss are calculated considering the risk currently being evaluated by the system. If the capacity calculation indicates that assigning a risk to a given threshold would result in the facility exceeding the Available Capacity Threshold, then the facility is removed from the database of Qualified Facilities or otherwise marked to indicate it is not available to accept assignment of a risk.

The risk concentration and capacity calculations are subject to change for a given facility as the facility is assigned new risks or as existing risks are de-assigned (i.e., an insurance policy lapses). That is, as each new risk is assigned to a given facility, the given facility has a higher risk concentration and lower available capacity. Thus, risk concentration and capacity must be continuously updated to ensure that a risk is not assigned to a facility that is not suitable for risk assignment. In traditional systems where the risk evaluation process does not occur in real time, changes to the risk concentration and capacity following identification of Qualified Facilities creates a particular problem where the evaluation process might need to be performed again. The system of the present invention avoids these pitfalls by enabling real-time evaluation of the risk and Disaggregation. This in turn permits risk concentration and capacity to be “reserved” by assignment of a given risk to a facility so that the given risk can be accounted for in subsequent risk evaluation processes even before a user completes the process of purchasing an insurance policy.

Following Risk Selection, Risk Rating, and Disaggregation, the system performs a Market Assignment Process, shown as the last, lower-most step in FIG. 2. The Market Assignment Process assigns risk to the remaining Qualified Facilities using a weighted, round-robin technique to help ensure balanced assignment of risks that does not overwhelm the risk concentration or capacity of any one facility over a specified time period. As Qualified Facilities begin to approach the predetermined Available Risk Threshold or Available Capacity Threshold, the weight for the relevant Qualified Facility is adjusted downward so that it is less likely to receive a risk assignment.

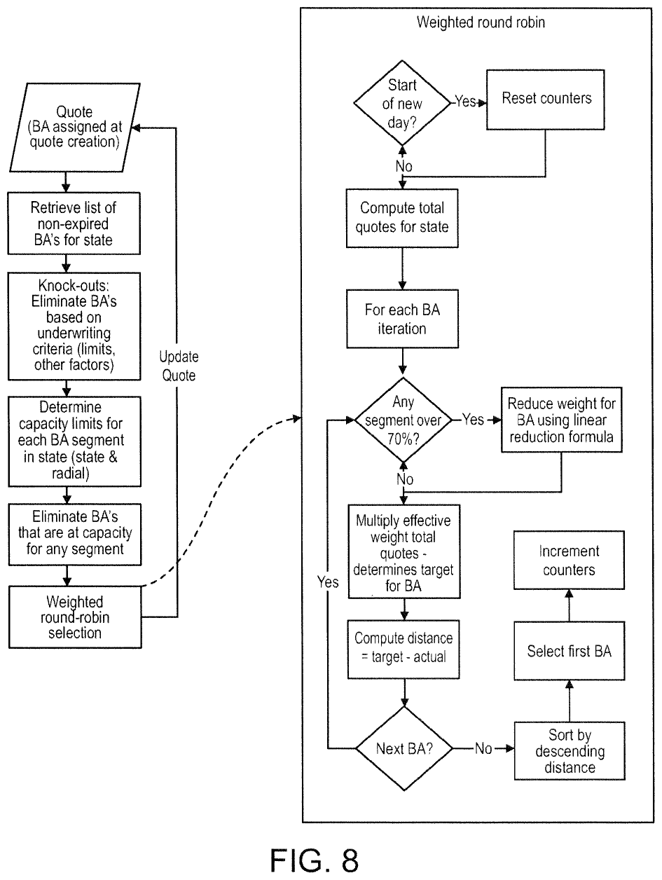

Details of the Market Assignment Process are illustrated in FIG. 8 for assignment occurring over a single day using an analysis of facility capacity. The Triton software engine 110 maintains a master counter of the total number of risk subjects assigned each day, which is shown in FIG. 8 as the number of Quotes. The Triton software engine also utilizes a facility counter to track how many risk subjects are assigned to a particular facility each day (referred to as a “BA” in FIG. 8).

The master counter and facility counter are reset at the start of each day, and for purposes of the Market Assignment Process, the risk subjects, or Quotes, are considered assigned to a facility at the time a Quote is created. As each risk subject to be assigned is evaluated at the Market Assignment step, each Qualified Facility remaining after the Risk Selection and Disaggregation Analyses, is reviewed by the Triton software engine 110 to determine whether the Qualified Facility is approaching a capacity threshold shown as 70% in FIG. 8. If a Qualified Facility has reached 70% of its Available Capacity Threshold value, the weight is adjusted downward.

Following weight adjustment, if necessary, the Triton software engine 110 uses the weights to calculate a Target number of risk assignments for each Qualified Facility and a Distance from the Target using the number of Actual Assigned number of risks. That is, based on the weighed values, the system calculates a difference between the number of risk assignments a Qualified Facility should have received and the number it has actually received. Once the Distance is calculated for each Qualified Facility, the Qualified Facilities are ranked in descending order according to the Distance. So, for example, if the Counter indicates there have been 100 risks assigned for a day, then a first facility and a second facility each having weights of 0.10 should have each received a Target 10 risk assignments. If the first facility has received 9 Actual Assignments and the second facility has received 5, then the Distance would be 1 and 5 respectively. The facilities would be ranked in descending Distance order 5 (second facility) and 1 (first facility)—and the second facility would receive the next risk assignment. The Triton software engine 110 would increment the Counter and begin the process again for each new risk to be assigned.

Although the foregoing description provides embodiments of the invention by way of example, it is envisioned that other embodiments may perform similar functions and/or achieve similar results. Any and all such equivalent embodiments and examples are within the scope of the present invention.

What is claimed is:

1. A system for electronically automating risk selection, rating, disaggregation, and assignment comprising at least one provider server processor, the at least one provider server processor coupled to at least one data storage device comprising non-transitory computer-readable medium with computer-readable code for instructing the at least one provider server processor, wherein:
(a) the data storage device further comprises at least one relational database comprising one or more facility identifiers, wherein each facility identifier is associated within the relational database with (i) one or more assigned risks, wherein the one or more assigned risks are each associated with an assigned risk value and assigned risk location data, (ii) facility risk selection rules, (iii) an available risk threshold, and (iv) an available capacity threshold;
(b) the computer-readable code implements Quoting System interface software that is configured to perform operations comprising
(i) generating one or more graphical user interfaces that are output to a display screen of an end user computing device, wherein each graphical user interface comprises one or more risk subject data input elements,
(ii) receiving risk subject data that is input to a first risk subject data input element, wherein the risk subject data comprises risk subject location data, and
(iii) passing the risk subject data to a Triton software engine;
(c) the computer-readable code implements the Triton software engine that is configured to perform operations comprising
(i) storing the risk subject data to the data storage device as part of a risk subject database record representing a Risk Subject,
(ii) passing the risk subject location data to a Mapping Application Programming Interface (API), wherein the Mapping API (A) interfaces with a map database by utilizing the risk subject location data to obtain risk subject geolocation coordinate data corresponding to the risk subject location data, and (B) returns the risk subject geolocation coordinate data to the Triton software engine,
(iii) passing the risk subject geolocation data to an Elevation API, wherein the Elevation API (A) interfaces with an elevation database by utilizing the risk subject geolocation coordinate data to obtain risk subject elevation data corresponding to the risk subject geolocation coordinate data, and (B) returns the risk subject elevation data to the Triton software engine,
(iv) performing a Risk Selection Analysis comprising the operations of
(A) retrieving the facility identifiers and facility risk selection rules from the data storage device, wherein the facility risk selection rules comprise facility risk geolocation rules,
(B) for one or more facility identifier, applying the associated facility risk geolocation rules to the risk subject geolocation coordinate data to deterniine one or more Qualified Facility Identifiers, and
(C) storing the Qualified Facility Identifiers to the data storage device as a list of Qualified Facilities,
(v) performing by the Triton software engine, a Rating Analysis utilizing the risk subject geolocation coordinate data and risk subject elevation data to generate a risk subject rating and a risk subject value,
(vi) performing a Disaggregation Analysis comprising the operations of
(A) defining a geographic disaggregation area, wherein the risk subject geolocation coordinate data falls within the geographic disaggregation area,
(B) for each Qualified Facility Identifier, utilizing the assigned risk location data to retrieve from the data storage device the assigned risk value for each assigned risk within the geographic disaggregation area,
(C) for each Qualified Facility Identifier, determining a risk disaggregation concentration based on a combination of the risk subject value and the assigned risk value for each assigned risk within the geographic disaggregation area,
(D) for each Qualified Facility Identifier, comparing the risk disaggregation concentration against the available risk threshold and removing the Qualified Facility Identifier from the list of Qualified Facilities when the risk disaggregation concentration exceeds the available risk threshold;
(vii) performing a Capacity Analysis comprising the operations of
(A) for each Qualified Facility Identifier, retrieving from the data storage device the assigned risk value for each assigned risk associated with the Qualified Facility Identifier,
(B) for each Qualified Facility Identifier, determining a total risk value based on a combination of the risk subject value and the assigned risk value for each assigned risk associated with the Qualified Facility Identifier,
(C) for each Qualified Facility Identifier, comparing the total risk value against the available capacity threshold and removing the Qualified Facility Identifier from the list of Qualified Facilities when the total risk value exceeds the available capacity threshold, and
(viii) performing a Market Assignment Process comprising the operations of
(A) for each Qualified Facility Identifier, determining an assigned risk distance value, and
(B) assigning the Risk Subject to the Qualified Facility Identifier associated with the lowest assigned risk distance value.

2. The system for electronically automating risk selection, rating, disaggregation, and assignment of claim 1, wherein
(a) after receiving the risk subject data that is input to the first risk subject data input element, the Quoting System interface software performs the further operation comprising generating a second graphical user interface that is output to the display screen of the end user computing device, wherein
(b) the second graphical user interface includes a second risk subject data input element as an integrated part of the second graphical user interface, and wherein
(c) the Quoting System interface software includes logic that selects a content of the second risk subject data input element based on the risk subject data that is input into the first risk subject data input element.

3. The system for electronically automating risk selection, rating, disaggregation, and assignment of claim 1, wherein:
(a) at least one of the risk subject data input elements is an interactive map; and
(b) the risk subject data is input by graphical selection of a geographic location on the interactive map using the end user computing device.

4. The system for electronically automating risk selection, rating, disaggregation, and assignment of claim 1, wherein:
(a) the risk subject geolocation coordinate data returned from the Mapping API comprises a plurality of geographic coordinate pairs representing points on a map;
(b) the risk subject elevation data returned from the Elevation API includes an elevation data value corresponding to each of the plurality of geographic coordinate pairs; and
(c) the Triton software engine performs further operations comprising
(i) passing at least one of the risk subject location data or the risk subject geolocation coordinate data to a Property API, wherein the Property API (A) interfaces with a property database by utilizing the risk subject location data or the risk subject geolocation coordinate data to obtain risk subject structure location data, and (B) returns the risk subject structure location data to the Triton software engine, and
(ii) determining a risk subject structure elevation by correlating the risk subject structure location data to at least one of the plurality of geographic coordinate pairs and the correlated elevation data value.

5. The system for electronically automating risk selection, rating, disaggregation, and assignment of claim 1, wherein:
(a) the risk subject geolocation coordinate data returned from the Mapping API comprises a plurality of geographic coordinate pairs representing points on a map;
(b) the risk subject elevation data returned from the Elevation API includes an elevation data value corresponding to each of the plurality of geographic coordinate pairs;
(c) at least one of the risk subject data input elements is an interactive map, and risk subject structure location data is graphically input to the interactive map using the end user computing device; and
(d) the Triton software engine performs the further operation comprising determining a risk subject structure elevation by correlating the risk subject structure location data to at least one of the plurality of geographic coordinate pairs and the correlated elevation data value.

6. The system for electronically automating risk selection, rating, disaggregation, and assignment of claim 1, wherein
(a) the facility risk selection rules further comprise facility risk elevation rules; and
(b) the Risk Selection Analysis further comprises the operation of, for one or more facility identifier, applying the associated facility risk elevation rules to the risk subject elevation data to determine one or more Qualified Facility Identifiers.

7. The system for electronically automating risk selection, rating, disaggregation, and assignment of claim 1, wherein the geographic disaggregation area is defined as being coextensive with a zip code.

8. The system for electronically automating risk selection, rating, disaggregation, and assignment of claim 1, wherein:
(a) the geographic disaggregation area is defined by a radial center point and a radial set point that extends a distance from the radial center point; and
(b) the operation of utilizing the assigned risk location data to retrieve to retrieve from the data storage device the assigned risk value for each assigned risk within the geographic disaggregation area, comprises the step of, for each Qualified Facility Identifier, determining whether the distance between the assigned risk location data and the radial center point is less than the radial set point.

9. The system for electronically automating risk selection, rating, disaggregation, and assignment of claim 1, wherein the risk subject value and the assigned risk value for each assigned risk are determined based on a total insured value calculation.

10. The system for electronically automating risk selection, rating, disaggregation, and assignment of claim 1, wherein the risk subject value and the assigned risk value for each assigned risk are determined based on an annual average loss calculation.

11. The system for electronically automating risk selection, rating, disaggregation, and assignment of claim 1, wherein
(a) the risk subject data that is input to the one or more risk subject data input elements comprises (i) a year of structure construction, and (ii) structure type information, and wherein
(b) the Triton software engine performs the further operations comprising
(i) passing at least one of the year of structure construction or the structure type information to a Construction Information API, wherein the Construction Information API (A) interfaces with a construction information database by utilizing the year of structure construction or the structure type information to obtain a structure construction height, and (B) returns the structure construction height to the Triton software engine, and
(ii) determining a front door elevation value utilizing the risk subject elevation data and the structure construction height.

12. The system for electronically automating risk selection, rating, disaggregation, and assignment of claim 11, wherein the Triton software engine performs the further operations comprising
(a) passing at least one of the risk subject location data or the risk subject geolocation coordinate data to a Base Flood Elevation API, wherein the Base Flood Elevation API (A) interfaces with a base flood elevation database by utilizing the risk subject location data or the risk subject geolocation coordinate data to obtain base flood elevation data; and (B) returns the base flood elevation data to the Triton software engine, and
(b) determining an elevation difference value utilizing the base flood elevation data and the front door elevation value.

13. A system for electronically automating risk selection, rating, disaggregation, and assignment comprising at least one provider server processor, the at least one provider server processor coupled to at least one data storage device comprising non-transitory computer-readable medium with computer-readable code for instructing the at least one provider server processor, wherein:
(a) the data storage device further comprises at least one relational database comprising one or more facility identifiers, wherein each facility identifier is associated within the relational database with (i) one or more assigned risks, wherein the one or more assigned risks are each associated with an assigned risk value and assigned risk location data, (ii) facility risk selection rules, (iii) an available risk threshold, and (iv) an available capacity threshold;
(b) the computer-readable code implements Quoting System interface software that is configured to perform operations comprising
(i) generating one or more graphical user interfaces that are output to a display screen of an end user computing device, wherein each graphical user interface comprises one or more risk subject data input elements, and
(ii) receiving initial risk subject data that is input to a first risk subject data input element;
(c) the computer-readable code implements the Triton software engine that is configured to perform operations comprising
(i) passing the initial risk subject data to a supplemental risk subject data application programming interface (API) that accesses a supplemental risk subject database to retrieve supplemental risk subject data,
(ii) storing the initial risk subject data and the supplemental risk subject data to the data storage device as Risk Subject Data as part of a database record representing a Risk Subject,
(iii) performing a Risk Selection Analysis comprising the operations of
(A) retrieving the facility identifiers and facility risk selection rules from the data storage device, and
(B) for one or more facility identifier, applying the associated facility risk selection rules to the Risk Subject Data to determine a list of Qualified Facility Identifiers,
(iv) performing by the Triton software engine, a Rating Analysis utilizing Risk Subject Data to generate a risk subject rating and a risk subject value,
(v) performing a Disaggregation Analysis comprising the operations of
(A) defining a disaggregation segment utilizing the risk subject data,
(B) for each Qualified Facility Identifier, utilizing the assigned risk data, retrieving from the data storage device the assigned risk value for each assigned risk within the disaggregation segment,
(C) for each Qualified Facility Identifier, determining a risk disaggregation concentration based on a combination of the risk subject value and the assigned risk value for each assigned risk within the disaggregation segment,
(D) for each Qualified Facility Identifier, comparing the risk disaggregation concentration against the available risk threshold and removing the Qualified Facility Identifier from the list of Qualified Facility Identifiers when the risk disaggregation concentration exceeds the available risk threshold,
(vi) performing a Capacity Analysis comprising the operations of
(A) for each Qualified Facility Identifier, determining a total risk value based on a combination of the risk subject value and the assigned risk value for each assigned risk associated with the Qualified Facility Identifier, and
(B) for each Qualified Facility Identifier, comparing the total risk value against the available capacity threshold and removing the Qualified Facility Identifier from the list of Qualified Facility Identifiers when the total risk value exceeds the available capacity threshold, and
(vii) performing a Market Assignment Process comprising the operations of
(A) for each Qualified Facility Identifier, determining an assigned risk distance value, and
(B) assigning the Risk Subject to the Qualified Facility Identifier associated with the lowest assigned risk distance value.

14. The system for electronically automating risk selection, rating, disaggregation, and assignment of claim 13, wherein:
(a) after receiving the initial risk subject data that is input to the first risk subject data input element, the Quoting System interface software performs the further operation comprising generating a second graphical user interface that is output to the display screen of the end user computing device, wherein
(b) the second graphical user interface includes a second risk subject data input element as an integrated part of the second graphical user interface, and wherein
(c) the Quoting System interface software includes logic that selects a content of the second risk subject data input element based on the initial risk subject data that is input into the first risk subject data input element.

15. The system for electronically automating risk selection, rating, disaggregation, and assignment of claim 14, wherein:
(a) the first risk subject data input element prompts an end user to enter risk subject data comprising a home type selected from a group consisting of a single-family house, a multi-story complex, and a manufactured home; and
(b) when the end user inputs single-single family house into the first risk subject data input element, the Quoting System interface software logic selects the content of the second risk subject data input element, wherein the content of the second risk subject data input element prompts the end user to select a structure type selected from a group consisting of a home on a slab, a home on a crawl space, a home with a basement, and a home on stilts or pilings.

16. The system for electronically automating risk selection, rating, disaggregation, and assignment of claim 13, wherein
(a) at least one of the risk subject data input elements is an interactive map; and
(b) the risk subject data is input by graphical selection of a geographic location on the interactive map using the end user computing device.

17. A method for electronically automating risk selection, rating, disaggregation, and assignment comprising the steps of:
(a) creating at least one relational database on a data storage device, wherein the relational database comprises one or more facility identifiers, wherein each facility identifier is associated within the relational database with (i) one or more assigned risks, wherein the one or more assigned risks are each associated with an assigned risk value and assigned risk location data, (ii) facility risk selection rules, (iii) an available risk threshold, and (iv) an available capacity threshold;
(b) generating by a Quoting System interface, a graphical user interface that is output to a display screen of an end user computing device, wherein the graphical user interface includes at least one integrated risk subject data input element;
(c) receiving by a Triton software engine, risk subject data relating to a Risk Subject, wherein the risk subject data is input to the risk subject data input element;
(d) passing by a Triton software engine, the initial risk subject data to at least one supplemental risk subject data application programming interface (API) that accesses a supplemental risk subject database to retrieve supplemental risk subject data;
(e) performing by a Triton software engine, a Risk Selection Analysis comprising the steps of, for one or more facility identifiers, applying the associated facility risk selection rules to the risk subject data to determine a list of Qualified Facility Identifiers;
(f) performing by the Triton software engine, a Rating Analysis utilizing the risk subject data to generate a risk subject rating and a risk subject value;
(g) performing by a Triton software engine, a Disaggregation Analysis comprising the steps of
(i) defining a disaggregation segment utilizing the risk subject data, where the disaggregation segment comprises a plurality of assigned risks,
(ii) for each Qualified Facility Identifier, utilizing the assigned risk data to identify each assigned risk within the disaggregation segment and retrieving from the data storage device, the assigned risk value for each assigned risk within the disaggregation segment,
(iii) for each Qualified Facility Identifier, determining a risk disaggregation concentration based on a combination of the risk subject value and the assigned risk value for each assigned risk within the disaggregation segment,
(iv) for each Qualified Facility Identifier, comparing the risk disaggregation concentration against the available risk threshold and removing the Qualified Facility Identifier from the list of Qualified Facility Identifiers when the risk disaggregation concentration exceeds the available risk threshold;
(h) performing by a Triton software engine, a Capacity Analysis comprising the steps of
(i) for each Qualified Facility Identifier, determining a total risk value based on a combination of the risk subject value and the assigned risk value for each assigned risk associated with the Qualified Facility Identifier, and
(ii) for each Qualified Facility Identifier, comparing the total risk value against the available capacity threshold and removing the Qualified Facility Identifier from the list of Qualified Facility Identifiers when the total risk value exceeds the available capacity threshold; and
(i) performing by the Triton software engine, a Market Assignment Process comprising the steps of
(i) for each Qualified Facility Identifier, determining an assigned risk distance value, and
(ii) assigning the Risk Subject to the Qualified Facility Identifier associated with the lowest assigned risk distance value.

18. The method for electronically automating risk selection, rating, disaggregation, and assignment of claim 18, wherein:
(a) the at least one supplemental risk subject data API comprises a Mapping API and an Elevation API, and wherein the method further comprises the steps of
(i) passing the risk subject data to the Mapping API, wherein the Mapping API (A) interfaces with the supplemental risk subject database by utilizing the risk subject data to obtain risk subject geolocation coordinate data corresponding to the risk subject data, and (B) returns the risk subject geolocation coordinate data to the Triton software engine, and
(ii) passing the risk subject geolocation data to an Elevation API, wherein the Elevation API (A) interfaces with the supplemental risk subject database by utilizing the risk subject geolocation coordinate data to obtain risk subject elevation data corresponding to the risk subject geolocation coordinate data, and (B) returns the risk subject elevation data to the Triton software engine; and wherein
(b) the facility risk selection rules comprise risk geolocation rules, and the Risk Selection Analysis further comprises the steps of, applying the facility risk geolocation rules to the risk subject geolocation coordinate data to determine one or more Qualified Facility Identifiers;
(c) performing the Risk Rating Analysis utilizing the risk subject geolocation coordinate data and the risk subject elevation data; and
(d) the Disaggregation Analysis further comprises the steps of
(i) defining the disaggregation segment as a geographic disaggregation area wherein the risk subject geolocation coordinate data falls within the geographic disaggregation area,
(ii) determining the risk disaggregation concentration based on a combination of the risk subject value and the assigned risk value for each assigned risk within the geographic disaggregation area.

19. The method for electronically automating risk selection, rating, disaggregation, and assignment of claim 19, wherein:
(a) at least one of the risk subject data input elements is an interactive map; and
(b) the method further comprises the step of inputting the risk subject data by graphical selection of a geographic location on the interactive map using the end user computing device.
